(19) United States
(12) Patent Application Publication
(10) Pub. No.: US 2017/0359721 A1
(43) Pub. Date: Dec. 14, 2017

(54) METHOD, SECOND SERVER AND SYSTEM FOR MANAGING ACCESS TO A FIRST SERVER

(71) Applicant: GEMALTO, INC., Austin, TX (US)

(72) Inventors: Meijuan DING, Austin, TX (US); Sebastien GRAVALLON, Austin, TX (US)

(73) Assignee: GEMALTO, INC., Austin, TX (US)

(21) Appl. No.: 15/181,969

(22) Filed: Jun. 14, 2016

(51) Int. Cl. H04W 12/06; H04W 12/04; H04B 1/3827; H04W 76/02; H04L 29/06

(52) U.S. Cl. CPC H04W 12/06; H04W 76/02; H04L 63/083; H04B 1/3833; H04L 63/06; H04W 12/04

(57) ABSTRACT

A method for managing access to a first server comprises intercepting a message including a connection request, for connecting to the first server. The message is sent at an initiative of a secure element, to the first server. A filtering rule, based upon a predetermined threshold relating to a rate or a number of connection requests, as a first filtering criterion, is accessed. The filtering rule comprises a second filtering criterion. A counter is modified for each intercepted message. The counter is compared to the predetermined threshold and, if the counter is equal to or greater than the predetermined threshold and the second filtering criterion is satisfied, a message including predefined output data is sent to the secure element. The output data controls or filters a session between the secure element and the first server.

### FIELD OF THE INVENTION

The invention relates generally to a method for managing access to a first server.

Moreover, the invention pertains to a second server for managing access to a first server.

Finally, the invention relates to a third server for managing access to a first server.

The present invention is notably applicable to a mobile radio-communication field wherein a Secure Element (or SE) includes a removable chip, like e.g. an Universal Integrated Circuit Card (or UICC) or a Subscribed Identity Module (or SIM) type card, as a chip medium, or an embedded (or incorporated) chip, such as an embedded UICC (or eUICC).

Within the present description, an SE is a smart object that includes a chip that protects, as a tamper resistant component, access to stored data and is intended to communicate data with an SE host device, like e.g. a mobile (tele)phone, a Machine to Machine (or M2M) or an Internet of Things (or IoT) device.

### STATE OF THE ART

As known per se, in a polling mechanism, a UICC, as an SE, takes an initiative to connect to an Over-The-Air (or OTA) server. The UICC may support one or several applications which use a UICC Administration Agent to poll the OTA server while implementing a specific request retry scheme.

However, each application supported by the UICC may poll the OTA server and implement an additional specific request retry in addition to the UICC Administration Agent request retry scheme. Thus, a huge amount (e.g. up to 5000 times per day) of polling requests per SE addressing the OTA server may be observed (in case of issue) while also impacting network elements, such as Home Subscriber Servers (or HSS). Such a polling data traffic increases the data traffic to the OTA server,

There is a need to provide a solution that allows reducing such a polling data traffic to the OTA server.

### SUMMARY OF THE INVENTION

The invention proposes a solution for satisfying the just herein above specified need by supplying a method for managing access to a first server.

According to the invention, the method comprises intercepting at least one message including a request, as a connection request, for connecting to the first server, the at least one message being sent, at an initiative of at least one secure element, to the first server, accessing at least one filtering rule, the at least one filtering rule being based upon at least one predetermined threshold relating to a rate or a number of connection requests, as a first filtering criterion, the at least one filtering rule comprising at least one second filtering criterion, modifying a counter for each intercepted message, comparing the counter to the at least one predetermined threshold, and sending, if the counter is equal to or is greater than the at least one predetermined threshold and the at least one second filtering criterion is satisfied, to the secure element a message including predefined output data, the output data allowing to control or filter a launched or an opened session between the secure element and the first server.

The principle of the invention consists in intercepting one or several connection requests that originate from one or several secure elements and are addressed to a first server. An intercepting server, as a second server, or a cooperating third server accesses a database with several filtering rules associated with each secure element. The filtering rules are based on one or several predefined thresholds relating to a number or rate of connection requests, as a first filtering criterion. The second (or the third) server modifies a pre-set counter. The second (or the third) server compares the counter to the threshold(s). If the counter matches or exceeds the threshold(s) and at least a second filtering criterion is satisfied, then the second server transmits to the secure element a message comprising predetermined output data allowing to control or filter a session launched or opened between the secure element and the first server.

It is noteworthy that the second server and/or the third server may constitute a software component of one and the same server, like e.g. the first server.

It is to be noted that only one server, instead of two or three servers, may implement the invention method.

To control or filter a session launched or opened between the secure element and the first server, the session is stopped or continued and closed.

The invention solution allows controlling and reducing a data traffic originating from the concerned secure element. To control and reduce the data traffic, the second server uses specific predefined output data that allows stopping a launched session between the secure element and the first server, or continuing a launched session by forwarding the connection request to the first server and closing a thus opened session. In such a last case, the first server may then download data, like e.g. notably a command(s) and/or an application(s), to the secure element, so as to reconfigure individually this latter. The secure element is reconfigured (or updated) after having executed at least part of the downloaded data that allows the secure element to not further issue any useless connection request to the first server.

Once a launched session is stopped or the secure element which is at the root of such a data traffic has been reconfigured and an opened session is closed, the secure element does thus no more send uselessly any connection request at its initiative.

The invention solution allows adapting specifically to the secure element and possibly its environment, such as notably its host device that may support an application(s) that cause(s) an incompatibility with an application(s) supported by the secure element.

The invention solution allows avoiding useless data traffic and thus not replacing the concerned secure element causing such a data traffic to the first server, like e.g. an OTA server.

To control and reduce a data traffic between a secure element and the first server, the invention solution does impact neither the rest of the data traffic nor any network element, like e.g. a HSS(s), involved between the secure element and the first server.

The invention solution does not impose any constraint as to a kind of the secure element.

As removable secure element, it may be a Subscriber Identity Module (or SIM) type card, a Secure Removable Module (or SRM), a smart dongle of the USB (acronym for “Universal Serial Bus”) type, a (micro) Secure Digital (or SD) type card or a Multi-Media type Card (or MMC) or any format card to be coupled to a host device.

According to still a further aspect, the invention is a second server for managing access to a first server.

According to the invention, the second server is configured to intercept at least one message including a request, as a connection request, for connecting to the first server, the at least one message being sent, at an initiative of at least one secure element, to the first server. The second server is configured to access at least one filtering rule, the at least one filtering rule being based upon at least one predetermined threshold relating to a rate or a number of connection requests, as a first filtering criterion, the at least one filtering rule comprising at least one second filtering criterion. The second server is configured to modify a counter for each intercepted message, compare the counter to the at least one predetermined threshold, and send, if the counter is equal to or is greater than the at least one predetermined threshold and the at least one second filtering criterion is satisfied, to the secure element a message including predefined output data, the output data allowing to control or filter a launched or an opened session between the secure element and the first server.

According to still an additional aspect, the invention is a system for managing access to a first server.

According to the invention, the system comprises a second server and a third server. The third server is connected to the second server. At least one of the second and the third server is configured to receive a message including information relating to at least one intercepted message comprising a request, as a connection request, for connecting to the first server, the at least one intercepted message being sent, at an initiative of at least one secure element, to the first server. At least one of the second and the third server is configured to access at least one filtering rule. The at least one filtering rule is based upon at least one predetermined threshold relating to a rate or a number of connection requests, as a first filtering criterion. The at least one filtering rule comprises at least one second filtering criterion. At least one of the second and the third server is configured to modify a counter for each intercepted message, compare the counter to the at least one predetermined threshold, and send, if the counter is equal to or is greater than the at least one predetermined threshold and the at least one second filtering criterion is satisfied, to the secure element a message including a request to send predefined output data, the output data allowing to control or filter a launched or an opened session between the secure element and the first server.

### BRIEF DESCRIPTION OF THE DRAWINGS

Additional features and advantages of the invention will be more clearly understandable after reading a detailed description of two preferred embodiments of the invention, given as indicative and non-limitative examples, in conjunction with the following drawings:

FIG. 1 illustrates a simplified diagram of an OTA server, as a first server, and one embodiment of a system with a second and a third server for managing access to the first server, so as to control or filter a data traffic generated by a secure element and addressed to the first server, according to the invention;

FIG. 2 represents a first embodiment of a flow of messages exchanged between the secure element and the system of FIG. 1, so that the system stops, at a security protocol level, a communication session launched by the secure element with the first server; and

FIG. 3 is a second embodiment of a flow of messages exchanged between the secure element and the system of FIG. 1, so that the system stops or continues and closes, at an application protocol level, a communication session opened between the secure element and the first server.

### DETAILED DESCRIPTION

Herein under is considered a case in which the invention method for managing access to an OTA server, as a first server, is implemented at the first server side by two servers, as a second server and a third server.

According to another embodiment (not represented), instead of being implemented by the second and the third server, the invention method for managing access to a first server is implemented by only one server, as a standalone entity. In other words, the first server does not cooperate with any other server, so as to control or filter any connection request that is addressed to the first server. According to such an embodiment, the first server is adapted to carry out the functions that are carried out by the second and the third server and that are described infra.

Naturally, the herein below described embodiments are only for exemplifying purposes and are not considered to reduce the scope of the invention.

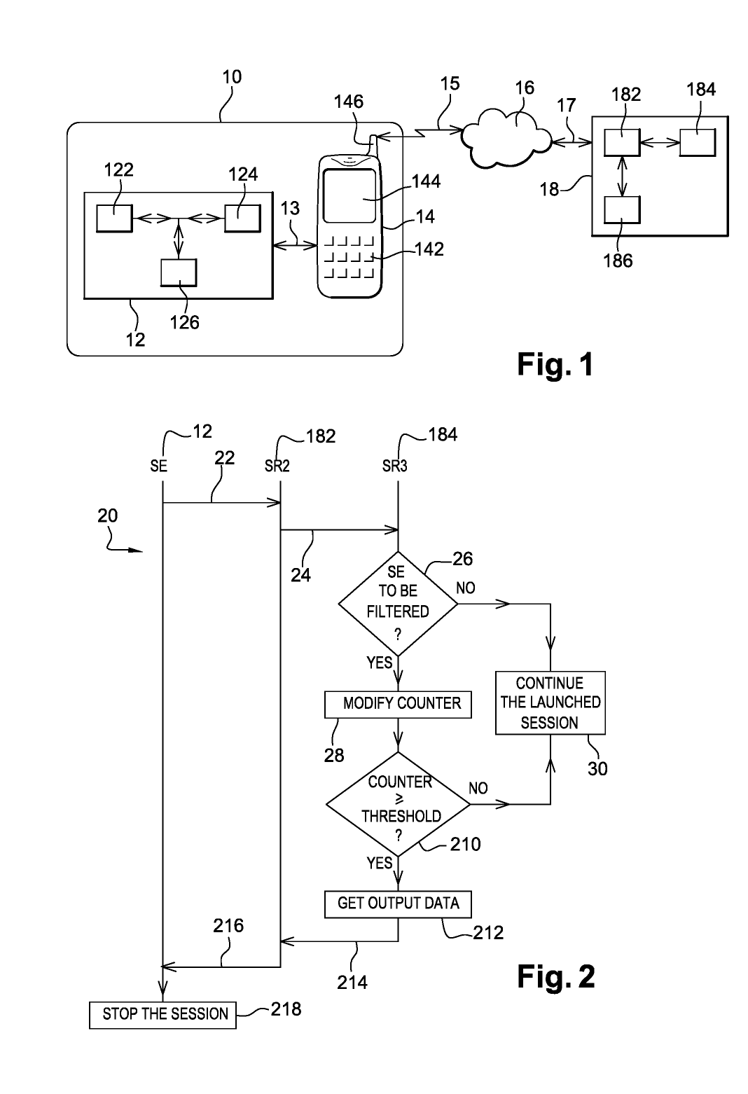

FIG. 1 shows schematically a Terminal Equipment (or TE) 10, a Home (or a visited) mobile Network 16 arid a Computer Network 18.

The TE 10 includes a chip 12 and a mobile phone 14, as a user terminal and a chip host device.

The chip 12 may be a chip, like e.g. an eUICC, incorporated, possibly in a removable manner, on a Printed Circuit Board (or PCB) of a terminal, as a chip host device.

Alternately, instead of an eUICC, the chip 12 may be a Trusted Execution Environment (or TEE), as a secure area of a terminal processor and a secured runtime environment.

The chip 12 may be carried by a medium, such as a smart card, like e.g. a UICC, a dangle, like e.g. a USB type dangle, or a wearable device, like e.g. a smart watch, a smart jewel or a, smart accessory.

The chip 12 may incorporate at least part of the terminal component(s), like e.g. a baseband processor, an application processor and/or (an)other electronic component(s).

The chip 12 is preferably included within an SE.

The SE may nevertheless have different form factors.

For sake of simplicity, the chip 12, the mobile phone 14, the Home mobile Network 16 and the Computer Network 18 are termed infra the SE 12, the host 14, the HN 16 and the CN 18 respectively.

The SE 12 is coupled to (or incorporated within) the host 14, as a terminal or a user terminal.

The CN 18 includes a first server 186, as a server to be addressed from the SE 12, a second server 182 and a third server 184, as servers allowing to control one or several messages issued from the SE 12.

For sake of simplicity, the first server 186, the second server 182 and the third server 184 are termed infra the SR1 186, the SR2 182 and the SRS 184 respectively.

The TE 10 is preferably under a radio coverage of the HN 16.

The (user) terminal or a machine in an M2M, as a terminal, may be fixed (i.e. not mobile) or mobile.

The (user) terminal may be a Personal Digital Assistant (or FDA), a vehicle, a Point Of Sale (or POS), an electricity meter, a water meter, a gas meter, any meter, a set-top box, a tablet computer, a Personal Computer (or PC), a desktop computer, a laptop computer, a video player, an audio player, a portable TeleVision (or TV), a media-player, a game console, a netbook, an electronic mobile equipment or accessory (like e.g. smart glasses, a smart watch or a smart jewel) or an IoT device.

Instead of a phone, the user terminal or the terminal may be any other computer device including means for processing data, comprising (or being connected to) wireless communication means for exchanging data with outside, and comprising (or being connected to) means for storing data.

Within the present description, the adjective “wireless” used within the expression “wireless communication means” denotes notably that the communication means communicates via one or several Long Range (or LR) Radio-Frequency (or RF) links set at e.g. several hundreds of MHz.

The host 14 is used for accessing preferably one or several mobile (radio-communication) networks, namely at least the HN 16.

The host 14 may be used for accessing, through the HN 16, the CN 18, the SR1 186, the SR2 182 and the SR3 184.

The host 14, as an SE host device, is coupled or connected, through a bi-directional link 13, to the SE 12.

Alternately, instead of being coupled to the SE 12, the host 14 incorporates the SE 12, as a chip embedded within the host 14.

The SE 12 may be under control of a host 14 (micro)processor(s) (or a (micro)controller(s)) (not represented), as data processing means.

The SE 12 belongs to a user, as a subscriber to a wireless service(s).

The SE 12 includes a (micro)processor(s) and/or a (micro)controller(s) 122, as data processing means, a memory(ies) 124, as data storing means, and one or several I/O interfaces 126 that are internally all connected, through an internal control and data bus 123, to each other.

The I/O interface(s) 126 allow(s) communicating data from the internal SE 12 components to the chip exterior and conversely.

The memory 124 stores an Operating System (or OS) and one or several applications or termed applets (when written in Java language).

The memory 124 may store data relating to a Uniform Resource Identifier (or URI), a Uniform Resource Locator (or URL), an Internet Protocol (or IP) address and/or other data relating to an external entity to be addressed, like e.g. the SR1 186.

The memory 124 may store a Mobile Station International Subscriber Directory Number (or MSISDN), an IP Multimedia Private Identity (or IMPI), an IP Multimedia PUblic identity (or IMPU) and/or a Network Access Identifier (or NAI), as an identifier(s) relating to the subscriber.

The memory 124 may store an International Mobile Equipment Identity (or IMEI), a URI, a URL and/or an email address, as an identifier(s) relating to the host 14.

The SE 12, more exactly through one or several supported applications, is able to send to the SR1 186 one or several connection requests to request a transmission of one or several data updates.

Such a data update(s) may include notably:
one or several commands;
one or several applications;
data for identifying a subscriber;
one or several keys for authenticating the subscriber;
one or several files;
one or several patches relating to the OS and/or the applications that are supported by the SE 12, like e.g. one or several SIM type applications.

The memory 124 stores, preferably in a secure manner, preferably one or several sets of data relating, each, to a subscription, as a wireless service(s).

Each set of data relating to one subscription includes preferably:
an IMSI, as data for identifying a subscriber and a (service) subscription identifier for accessing a mobile network;
a key Ki, as a key for authenticating the subscriber to the network and a Network Authentication Key (or NAK), allowing to authenticate the subscriber to the mobile network;
Milenage (or the like), as a network authentication algorithm, allowing to authenticate the subscriber to the mobile network;
a file system including one or several Elementary Files (or EF);
one or several security keys, like e.g. a key(s) for encrypting/decrypting data and/or a key(s) for signing data a key(s), as secret data; and/or
one or several credentials, like e.g. a user name and/or an IDentifier (or ID) of the subscriber, as data relating to the user.

The processor 122 processes, controls and communicates internally data with all the other components incorporated within the SE 12 and, through the I/O interface(s) 126, with the chip exterior.

The processor 122 executes or runs one or several supported applications.

The processor 122 is preferably able to initiate an action(s), in order to interact directly with the outside world, in an independent manner of the host 14. Such a capacity of interaction at the initiative of the SE 12 is also known as being a proactive capacity in which the SE 12 plays a role of a master while the host 14 plays a role of a slave.

The SE 12 is thus able to send, at its own initiative, through or to the host 14, a message including a proactive command, like e.g. an “Open Channel (or OC) type command”, for establishing or requesting a connection to an identified remote server, like e.g. the SR1 186.

The host 14 includes data processing means, such as a (micro)processor(s) and/or a micro(controller(s)), data storing means (not represented), as a phone memory, and one or several I/O interfaces connected, through a control and data bus (not represented), to each other.

Optionally, the host 14 includes (or is connected or coupled to) a display screen 142 and a keyboard 144, as a Man Machine Interface (or MMI).

The host memory stores an OS and one or several applications.

The host memory may comprise one or several memories.

The host memory stores preferably e.g. an International Mobile Equipment Identity (or IMEI), a URI, a URL and/or an email address, as an identifier(s) relating to the host 14.

The host I/O interfaces include one or several I/O interfaces for exchanging data with outside of the host 14.

The host I/O interface with the SE 12 may be an International Organization for Standardization (or ISO) 7816 and/or USB type interface(s), as a contact interface(s), when the SE 12 is inserted, possibly in a removable manner, within the host 14.

Alternately or additionally, the host I/O interface with the SE 12 includes or is connected to a ConTact-Less (or CTL) interface(s), like e.g. an ISO 14443, by using preferably a Short Range (or SR) RF link(s). The SR RF link(s) may be related to any technology that allows the host 14 to exchange data, through a CTL link(s) with the SE 12. The SR RF may be related to a Near Field Communication (or NFC) type technology, a Bluetooth type technology and/or a Bluetooth low energy type technology, as a CTL technology(s).

The host 14 is able to communicate data, over an antenna 146, through a wireless link 15, with the HN 16.

The HN 16 is a home or a visited network. The HN 16 is related to a home or a foreign country with respect to the subscriber. The HN 16 is connected, through a bi-directional link 17, to the CN 18.

Alternately or additionally, the host 14 is connected, through a Network Access Point (or NAP) (not represented), like e.g. a set-top box, to the CN18.

The CN 18 comprises or is connected to an Internet type network (not represented). The CN 18 comprises the SR1 186, the SR2 182 and the SR3 184.

According to a particular embodiment, only one and the same computer hosts the SR1 186, the SR2 182 and the SR3 184, as three software components or applications.

Alternatively, each of the SR1 186, the SR2 182 and the SR3 184 is hosted by a specific and separate computer.

Alternately, one computer hosts one server, like e.g. the SR1 186, while another computer hosts the two other servers, like e.g. the SR2 182 and the SR3 184.

The computer (or each computer) includes a processor(s), as data processing means (not represented), comprises and/or is connected to a memory(ies), as data storing means (not represented), and one or several I/O interfaces (not represented).

The SR1 186 is identified by a URI, a URL, an IP address or the like, as an identifier relating to the SR1 186 or server identifier. The server identifier may be stored within e.g. the SE memory 124 and/or an SE host device memory.

The SR1 186 may be operated by a mobile radio-communication network operator, as a Mobile Network Operator (or MNO) or a Mobile Virtual Network Operator (or MVNO), a service provider or on its behalf.

The SR1 186 may be included within an ecosystem (not represented), like e.g. a MNO back-end system, that comprises several servers managed by the service provider or on its behalf.

The SR1 186 may be an OTA type server, a Trusted Service Manager (or TSM) type server or the like.

The SR1 186 is preferably dedicated to running an application for managing a first database and communicating data of the first database to outside.

A memory(ies) that is(are) accessible from the SR1 186 stores the first database relating to a set of one or several secure elements, as client devices.

The first database includes a set of one or several identifiers relating, each, to a secure element, like e.g. the SE 12, that are, each, associated with data to be transmitted to the concerned secure element.

The identifier(s) relating to a secure element may include one or several identifiers relating to the SE 12, like e.g. an Integrated Circuit Card Identifier (or ICCID), an eUICC IDentifier (or elD), an Electronic Serial Number (or ESN), a User Identity Module IDentifier (or UIMID), or an Expanded User Identity Module IDentifier (or EUIMID), and/or one or several identifiers relating to the host 14, like e.g. an IMEI, a Mobile Station International Subscriber Directory Number (or MSISDN), a Mobile Equipment IDentifier (or MEID) or an IMEI Software Version (or IMEI SV).

The data to be transmitted to the concerned secure element may include non-executable data and/or executable data, like e.g. a command(s) and/or an application(s). The data to be transmitted to the concerned secure element allows reconfiguring the secure element by modifying the behaviour of the secure element, so that the secure element does no more issue any useless connection request to the SR1 186.

The SR1 186 is able to receive from a plurality of secure elements, like e.g. the SE 12, one or several messages, like e.g. a Short Message Service (or SMS) or a HyperText Transfer Protocol (or HTTP) type message(s), including a connection request for connecting to the SR1 186 accompanied with or including possibly an identifier relating to a secure element, like e.g. an ICCID. The message(s) including the connection request is(are) sent at an initiative of the secure element arid is addressed to the SR1 186.

The SR1 186 or another server of a service provider, like e.g. an MNO provisioning server, may be configured to send to the secure element data for provisioning the secure element.

The SR2 182 possibly in cooperation with the SR3 184, as a controlling server, is dedicated to running an application for controlling a message(s) that is(are) addressed to the SR1 186 and originating from one or several secure elements at their initiative.

The SR2 182 may be operated by a mobile radio-communication network operator, as an MNO or an MVNO, a service provider or on its behalf.

The SR2 182 is preferably included within the ecosystem that also manages the SR1 186.

The SR2 182 may be a reverse-proxy type server or the like.

The SR2 182 possibly in cooperation with the SR3 184 is used for managing access to the SR1 186.

According to a particular invention embodiment, the SR2 182 manages a security protocol(s) that may be used for exchanging between each secure element of a fleet and the SR1 186.

The SR2 182 is configured to intercept one or several messages that include a connection request for connecting to the SR1 186. The message(s) is(are) sent at an initiative of a secure element(s), like e.g. the SE 12.

The SR2 182 possibly in cooperation with the SR3 184 (or the SR3 184) is arranged to access one or several filtering rules that are associated individually with the secure elements to be managed.

The SR3 184 (or the SR2 182) is preferably dedicated to running an application for managing a second database and communicating data of the second database to outside.

A memory(ies) that is(are) accessible from the SR3 184 (or the SR2 182) stores the second database relating to a set of one or several identified secure elements possibly in association with one or several corresponding identified (host) devices.

The identifier(s) relating to a secure element may include one or several identifiers relating to the SE 12, like e.g. an ICCID, an eID, an ESN, a UIMID, or an EUIMID, and possibly one or several identifiers relating to the host 14, like e.g. an IMEI, a MSISDN, a MEID or an IMEI SV.

The second database includes a set of one or several identifiers relating, each, to a secure element, like e.g. the SE 12, possibly in association with one or several host devices, that is associated with a corresponding status relating to a filtering (or a non-filtering), several filtering rules, a corresponding counter, a corresponding threshold(s) and a corresponding filtering process associated with predetermined output data to be used for the filtering.

The filtering status may be a flag the value of which is predetermined, like e.g. “1”, when the concerned client device is to be filtered when several filtering rules are satisfied or another predetermined value, like e.g. “0”, when the client device is not to be filtered.

The filtering rules are individually configurable and personalized for each concerned secure element that is comprised within a fleet of secure elements to be thus managed.

The filtering rules are based on one or several predetermined thresholds relating, each, to a rate or a number of connection requests, as a first filtering criterion.

The filtering rules comprise at least a second filtering criterion.

The second filtering criterion may include identifying the secure element, as being included within a predetermined first set of one or several secure elements eligible to a filtering.

The second filtering criterion may include identifying a (SE host) device, as being included within a predetermined second set of one or several devices eligible to a filtering.

The second filtering criterion may include identifying the secure element and a (host) device, as being included within a predetermined third set of an association of one or several secure elements with one or several devices eligible to a filtering. The association of the secure element(s) with the device(s) is eligible to a filtering. The device incorporates or is coupled to the secure element.

The SR3 184 (or the SR2 182) possibly in cooperation with the SR2 182 is adapted to modify a counter for each intercepted message relating to the corresponding (identified) secure element. The counter is preconfigured with a predetermined value, like e.g. “0”. To modify the counter, the SR3 184 (or the SR2 182) updates, increments or decrements (in a predictable manner) the counter by one or several units for each intercepted message relating to the concerned secure element.

The SR3 184 (or the SR2 182) is configured to compare the counter to a predetermined threshold relating to a rate of connection requests, like e.g. 10 connection requests per second, minute, day or week, or a number of connection requests, like e.g. 100 connection requests, relating to the concerned secure element.

In the case of an incrementation or an update of the counter for each intercepted message, while the counter is less than the predetermined threshold relating to the rate or the number of connection requests and the second filtering criterion is not satisfied, the SR3 184 possibly in cooperation with the SR2 182 (or the SR2 182) is arranged to forward to the SR1 186 the message(s) including the connection request. If the counter is equal to or greater than the predetermined threshold relating to the rate or the number of connection requests and the second filtering criterion is satisfied, the SR3 184 possibly in cooperation with the SR2 182 is adapted to send to the secure element a message that includes predefined output data. The predefined output data is specific to the concerned secure element. The predefined output data allows filtering the data flow by stopping a launched session between the secure element and the SR1 186 or continuing and closing a session opened between the secure element and the SR1 186.

The data to be downloaded or transmitted to the concerned secure element may include non-executable data and/or executable data, like e.g. a command(s) and/or an application(s) that may update the application supported by the concerned secure element and generates such a data traffic. The data to be transmitted to the concerned secure element allows modifying the behaviour of the concerned secure element, so that the secure element does no more issue any useless connection request to the SR1 186.

FIG. 2 depicts an exemplary embodiment of a message flow 20 involving the SE 12, the SR2 182 and the SR3 184, so as to stop a (communication) session that is launched by the SE 12 at a security protocol level.

The security protocol comprises a Transport Layer Security (or TLS) type protocol.

The SE 12 is at an initiative of a connection request to the SR1 186.

The SR2 182 intercepts any message which includes a connection request for connecting to the SR1 186.

To initiate such a connection to the SR1 186, the SE 12 initiates a TLS handshake with the SR2 182.

During the TLS handshake, the SE 12 sends to the SR2 182 preferably a ClientKeyExchange type message 22 that is included within a mechanism for generating a key(s) relating to a session for communicating with the SR1 186.

The ClientKeyExchange type message 22 includes a Pre-Shared Key (or PSK) IDentifier (or ID), a Diffie-Hellman Key (or DHK) ID or the like.

The ClientKeyExchange type message 22 includes, as an IDentifier(s) (or ID(s)), one or several IDs relating to the SE 12, such as an ICCID, and/or one or several IDs relating to the host 14.

The SR2 182 extracts at least the (received) ID(s) and a date relating to the launched session, as a (communication) session date.

The SR2 182 sends to the SR3 184 a message 24 including at least the ID(s) and the session date.

The SR3 184 identifies, based on the received ID(s), at least the concerned SE.

The SR3 184 accesses the second database. The second database includes a set of IDs relating to secure elements, possibly IDs relating to an associated (host) device(s), the associated filtering status, the associated counters, the associated predetermined thresholds and the associated predetermined output data to be sent by the SR2 182 to the concerned secure element.

The SR3 184 stores within the second database, for each intercepted message, the session date associated with the corresponding SE.

The SR3 184 verifies 26 whether the corresponding identified SE is or is not to be filtered by using the filtering status relating to the concerned secure element that is associated with the ID(s).

If the corresponding identified SE is not to be filtered, then the SR3 184 allows the SR2 182 to continue 30 the session launched by the concerned secure element by following a filtering process that is described infra.

Otherwise, i.e, if the corresponding identified SE is to be filtered, i.e. belongs to a blacklist, the SR3 184 modifies 28 the counter, for each intercepted message, that is associated with the concerned secure element.

To modify the counter that changes thus for each intercepted message, the SR3 184 increments (or decrements or updates) the counter by one or several units according to a predetermined process.

Once the counter has been modified, the SR3 184 compares 210 the counter to a predetermined threshold. To compare the counter to the predetermined threshold, the SR3 184 verifies whether the counter is e.g. equal to or greater than the predetermined threshold. Alternately, the SR3 184 verifies whether the counter is less than the predetermined threshold.

The predetermined threshold may be e.g. two or three connection requests per second, minute, day (or week), as being considered as an abnormal behavior for the concerned secure element.

If the counter is less than the predetermined threshold, then the SR3 184 allows the SR2 182 to continue 30 the session launched by the concerned secure element while following a predetermined filtering process that is described infra. The predetermined filtering process includes filtering rules that are registered within the second database for the concerned secure element. The corresponding filtering rules may be to continue the security protocol session and to stop the launched session at an application protocol level or to continue the security protocol session and the application protocol session and to close, after a transmission of data to re-configure the secure element, the session thus opened with the SR1 186.

Otherwise, i.e. if the counter is equal to or greater than the predetermined threshold, the SR3 184 gets 212 from the second database the predetermined output data that is specifically associated with the concerned secure element.

The predetermined output data includes one or several first error or status codes comprised within the concerned security protocol.

The predetermined output data may be, for e.g. the TLS, one or several elements of a group comprising e.g. close_notify(0), unexpected_message(10), bad_record_mac(20), decryption_failed_RESERVED(21), record_overflow(22), decompression_failure(30), handshake_failure(40), no_certificate_RESERVED(41), bad_certificate(42), unsupported_certificate(43), certificate_revoked(44), certificate_expired(45), certificate_unknown(46), illegal_parameter(47), unknown_ca(48), access_denied(49), decode_error(50), decrypt_error(51), export_restriction_RESERVED(60), protocol_version(70), insufficient_security(71), internal_error(80), user_canceled(90), no_renegotiation(100) and unsupported_extension(110).

The predetermined output data is to be sent to the secure element that has launched the pending session.

The SR3 184 sends to the SR2 182 a message 214 including the predetermined output data.

The SR2 182 extracts the (received) predetermined output data.

Then, the SR2 182 sends to the SE 12 a message 216 including the predetermined output data.

The SE 12 interprets or executes the predetermined output data. Such an interpretation or an execution of the predetermined output data allows stopping the launched session and thus restricting access to the SR1 186.

The SE 12 stops 218 the TLS handshake and therefore terminates the launched session at the TLS level, i.e. the layer 5 of the Open Systems Interconnection (or OSI) model, without forwarding the connection request to the SR1 186.

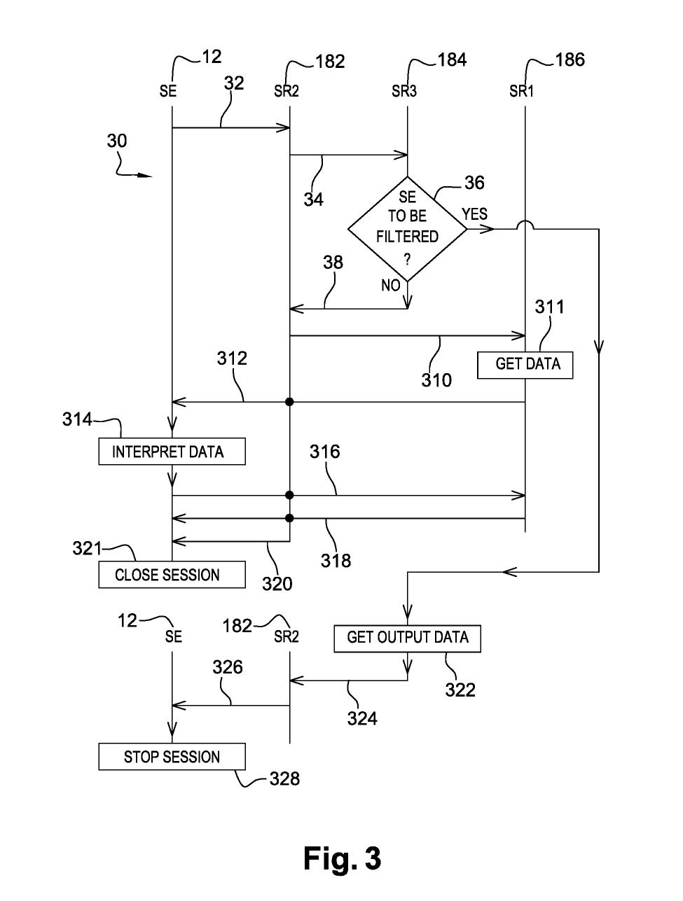

FIG. 3 depicts an exemplary embodiment of a message flow 30 involving the SE 12, the SR2 182 arid the SR3 184, so as to stop, at an application protocol level, the session launched by the SE 12 or continue and close, after a download of data allowing to reconfigure the SE 12, a session opened with the SR1 186.

The SE 12 uses one or several application protocols for exchanging with the SR1 182. The SE 12 may have previously used one or several security protocols for exchanging with the SR1 182 i.e. without having been stopped at the security protocol level.

The application protocol(s) comprise(s) an HTTP, a Session Initiation Protocol (or SIP) and/or a Simple Mail Transfer Protocol (or SMTP).

It is assumed that the SE 12 uses only an HTTP type protocol for exchanging with the SR1 186 while being at an initiative of a connection request to the SR1 186.

The SR2 182 intercepts any message which includes a connection request for connecting to the SR1 186.

To initiate such a connection to the SR1 186, after a possible successful at a security protocol level with the SR2 182, the SE 12 sends through the SR2 182 preferably a HTTP POST/Activation?msg type message 32 or the like, so as to get data from the SR1 186.

The HTTP POST/Activation?msg type message 32 includes a header. The header includes, as an ID(s), one or several SE 12 IDs, such as an ICCID, and/or one or several host 14 IDs.

The SR2 182 extracts at least the (received) D(s), a date relating to the launched session, as a (communication) session date, and possibly a security protocol session ID.

The SR2 182 sends to the SR3 184 a message 34 including at least the ID(s), the session date and possibly the security protocol session ID.

The SR3 184 identifies at least the concerned SE based on the received ID(s).

The SR3 184 accesses the second database. The second database includes a set of IDs relating to secure elements, possibly IDs relating to an associated (host) device(s), the associated filtering status, the associated counters, the associated predetermined thresholds and the associated predetermined output data to be sent by the SR2 182 to the concerned secure element.

The SR3 184 stores within the second database, for each intercepted message, the session date and possibly the security protocol session ID associated with the corresponding SE.

The SR3 184 verifies 36 whether the corresponding identified SE is or is not to be filtered by using the filtering status relating to the concerned secure element that is associated with the ID(s).

If the corresponding identified SE is not to be filtered, then the SR3 184 sends to the SR2 182 a message 38 including a request to forward the (received) connection request to the SR1 186 along with the concerned secure element ID and possibly the concerned security protocol session ID. The SR2 182 sends to the SR1 186 a message 310 including the connection request along with the concerned secure element ID. Then, the SR1 186 retrieves 311 from the first database data to be downloaded to the concerned secure element, like e.g. one or several Application Protocol Data Unit (or APDU) type commands and/or an application. The SR1 186 sends, through the SR2 182, to the SE 12 a message 312 including a request response, like e.g. “200 OK”, as an HTTP POST Response, including in the header, a next URI and a content type, and including in the body the (retrieved) data. The SE 12 interprets 314 and possibly executes the received data. Once the SE 12 has taken into account the received data, the SE 12 sends, through the SR2 182, to the SR1 186 a message 316 including, as a result, like e.g. HTTP POST Next-URI, including in the header, the content type, and including in the body the result(s). Then, the SR1 186 sends, through the SR2 182, to the SE 12 a message 318 including a request response, like e.g. “204 No Content”, as an HTTP POST Response, including in the header, no next URI, and including, in the body, no data. Finally, the SR2 182 which knows that no further data is to be downloaded from the SR1 186 to the SE 12 sends to the SE 12 a message 320 including a connection closure command. Thus, the SE 12 terminates or closes 321 the session at the application protocol level.

Otherwise, i.e. if the corresponding identified SE is to be filtered, i.e. belongs to a blacklist, the SR3 184 gets 322 from the second database the predetermined output data that is specifically associated with the concerned secure element.

The predetermined output data includes one or several second error or status codes comprised within the concerned application protocol.

The predetermined output data may be, for e.g. the HTTP, one or several elements of a group comprising e.g. HTTP POST RESPONSE-204 and HTTP POST RESPONSE-503.

The predetermined output data is to be sent to the secure element that has launched the pending session.

The predetermined output data allows stopping the session at the application protocol level and thus restricting access to the SR1 186.

Optionally, prior to getting 322 from the second database the predetermined output data, the SR3 184 modifies (not represented) the counter, for each intercepted message, that is associated with the concerned secure element.

To modify the counter that changes thus for each intercepted message, the SR3 184 increments (or decrements or updates) the counter by one or several units according to a predetermined process.

Once the counter has been modified, the SR3 184 compares (not represented) the counter to a predetermined threshold. To compare the counter to the predetermined threshold, the SR3 184 verifies whether the counter is e.g. equal to or greater than the predetermined threshold. Alternately, the SR3 184 verifies whether the counter is less than the predetermined threshold.

The predetermined threshold may be e.g. two or three connection requests per day (or week), as being considered as an abnormal behavior for the concerned secure element.

If the counter is less than the predetermined threshold, then the SR3 184 allows the SR2 182 to continue (not represented) the session launched by the concerned secure element while forwarding the connection request to the SR1 186 and then closing, after a transmission of data, such as an application and/or OS patch(es), to re-configure the secure element, the session thus opened with the SR1 186.

Otherwise, i.e. if the counter is equal to or greater than the predetermined threshold, the SR3 184 gets 322 from the second database the predetermined output data that is specifically associated with the concerned secure element.

The SR3 184 sends to the SR2 182 a message 324 including the predetermined output data.

The SR2 182 extracts the (received) predetermined output data. Then, the SR2 182 sends to the SE 12 a message 326 including the predetermined output data.

The SE 12 interprets or executes the predetermined output data. Such an interpretation or an execution of the predetermined output data allows stopping the launched session.

The SE 12 stops 328 the launched session at the application protocol level, i.e. the layer 7 of the OSI model, without forwarding the connection request to the SR1 186.

The invention solution is simple and efficient to reduce the data traffic by stopping or closing a communication session at a security protocol level and/or at an application protocol level.

The invention solution allows controlling or filtering a (polling) data traffic generated by a secure element, as an initiator of an exchange of messages with a target server.

The invention solution allows adapting a connection rejection to the environment of the concerned secure element.

The invention solution allows avoiding thus a replacement of the concerned secure element.

The invention solution does impact neither the rest of the data traffic nor any network element nor a possible host user.

The invention solution is transparent to the user (no need of any MMI). Thus, the host user, when applicable, benefits from a good user experience.

1. A method for managing access to a first server, comprising:
intercepting at least one message including a request, as a connection request, for connecting to the first server, the at least one message being sent, at an initiative of at least one secure element, to the first server;
accessing at least one filtering rule, the at least one filtering rule being based upon at least one predetermined threshold relating to a rate or a number of connection requests, as a first filtering criterion, the at least one filtering rule comprising at least one second filtering criterion;
modifying a counter for each intercepted message;
comparing the counter to the at least one predetermined threshold; and
sending, if the counter is equal to or is greater than the at least one predetermined threshold and the at least one second filtering criterion is satisfied, to the secure element a message including predefined output data, the output data allowing to control or filter a launched or an opened session between the secure element and the first server.

2. Method according to claim 1 wherein the at least one intercepted message is included within a mechanism for generating at least one session key, and the at least one intercepted message includes at least one identifier relating to the secure element and/or at least one identifier relating to the device, the device incorporating or being coupled to the secure element.

3. Method according to claim 1, wherein the at least one intercepted message includes a header including at least one identifier relating to the secure element and/or at least one identifier relating to the device, the device incorporating or being coupled to the secure element.

4. Method according to claim 1, wherein the at least one second filtering criterion includes identifying at least one element of a group comprising:
the secure element as being included within a predetermined first set of at least one secure element eligible to a filtering;
a device as being included within a predetermined second set of at least one device eligible to a filtering, the device incorporating or being coupled to the secure element;
the secure element and a device as being included within a predetermined third set of an association of at least one secure element with at least one device, the association of the at least one secure element with the at least one device being eligible to a filtering, the device incorporating or being coupled to the secure element.

5. Method according to claim 1, wherein, the secure element using at least one security protocol, the predefined output data includes at least one first error or status code comprised within the security protocol.

6. Method according to claim 5, wherein the at least one security protocol comprises a TLS type protocol.

7. Method according to claim 1, wherein, the secure element using at least one application protocol for exchanging with the first server, the predefined output data includes at least one second error or status code comprised within the application protocol.

8. Method according to claim 1, wherein, the secure element using at least one security protocol and at least one application protocol for exchanging with the first server, the predefined output data includes at least one first error or status code comprised within the security protocol and/or at least one second error or status code comprised within the application protocol.

9. A second server for managing access to a first server,
wherein the second server is configured to:
intercept at least one message including a request, as a connection request, for connecting to the first server, the at least one message being sent, at an initiative of at least one secure element, to the first server;
access at least one filtering rule, the at least one filtering rule being based upon at least one predetermined threshold relating to a rate or a number of connection requests, as a first filtering criterion, the at least one filtering rule comprising at least one second filtering criterion;
modify a counter for each intercepted message;
compare the counter to the at least one predetermined threshold; and
send, if the counter is equal to or is greater than the at least one predetermined threshold and the at least one second filtering criterion is satisfied, to the secure element a message including predefined output data, the output data allowing to control or filter a launched or an opened session between the secure element and the first server.

10. A system for managing access to a first server,
wherein, the system comprising a second server and a third server, the third server being connected to the second server, at least one of the second and the third server is configured to:
receive a message including information relating to at least one intercepted message comprising a request, as a connection request, for connecting to the first server, the at least one intercepted message being sent, at an initiative of at least one secure element, to the first server;
access at least one filtering rule, the at least one filtering rule being based upon at least one predetermined threshold relating to a rate or a number of connection requests, as a first filtering criterion, the at least one filtering rule comprising at least one second filtering criterion;
modify a counter for each intercepted message;
compare the counter to the at least one predetermined threshold; and
send, if the counter is equal to or is greater than the at least one predetermined threshold and the at least one second filtering criterion is satisfied, to the secure element a message including a request to send predefined output data, the output data allowing to control or filter a launched or an opened session between the secure element and the first server.
